(19) United States
(12) Patent Application Publication
(10) Pub. No.: US 2013/0207588 A1
(43) Pub. Date: Aug. 15, 2013

(54) INITIAL DRIVING APPARATUS AND METHOD OF TWO-PHASE SRM

(71) Applicants: Dong Hee Lee, Busan (KR); Jin Woo AHN, Busan (KR); Geun Min LIM, Busan (KR); Byeong Han KIM, Gyunggi-do (KR)

(72) Inventors: Dong Hee Lee, Busan (KR); Jin Woo AHN, Busan (KR); Geun Min LIM, Busan (KR); Byeong Han KIM, Gyunggi-do (KR)

(73) Assignee: SAMSUNG ELECTRO-MECHANICS CO., LTD., Gyunggi-do (KR)

(21) Appl. No.: 13/493,771

(22) Filed: Jun. 11, 2012

(30) Foreign Application Priority Data
Feb. 15, 2012 (KR) 1020120015486

(51) Int. Cl. H02P 1/46

(52) U.S. Cl. 318/701

(57) ABSTRACT

Disclosed herein are an initial driving apparatus and method of a two-phase switched reluctance motor (SRM). The initial driving apparatus of a two-phase SRM includes: a driving unit; a current measuring unit; a memory; and a controlling unit comparing the currents measured in the current measuring unit and a difference between the currents with the data currents and the difference between the data currents stored in the memory to determine an initial position, thereby initially driving the SRM. Therefore, the two-phase SRM may be stably operated.

### CROSS REFERENCE TO RELATED APPLICATION

This application claims the benefit of Korean Patent Application No. 10-2012-0015486, filed on Feb. 15, 2012, entitled “Two Phase Initial Driving Apparatus and Method Thereof”, which is hereby incorporated by reference in its entirety into this application.

### BACKGROUND OF THE INVENTION

1. Technical Field

The present invention relates to an initial driving apparatus and method of a two-phase switched reluctance motor (SRM).

2. Description of the Related Art

An SRM has a simple structure, high operation efficiency, and excellent traction driving characteristics. Therefore, in accordance with the social demand for both of economical efficiency and performance, the development for commercialization of the SRM has been actively conducted.

In order to accurately and precisely control a speed and a torque in an industrial application of this SRM, positional information of a rotor is necessarily required. To this end, a positional sensor such as a magnetic sensor, a resolver, an encoder, and the like, is used.

However, this rotor position detection method requires separate signal processing, is complicated in a design and processing process, and is sensitive to environmental factors such as high temperature, high pressure, or the like, such that it is difficult to use this rotor position detection method in a poor environment and a cost increase is caused. Therefore, in order to solve these problems, research into several sensorless control methods has been conducted.

Meanwhile, since a two-phase SRM has a driving circuit simpler than that of a three-phase SRM, it has been prominent in an application such as a fan, a blower, and a compressor. However, in these industrial applications, it is very difficult to attach a positional sensor such as an encoder, or the like, and there is a cost problem. Therefore, research into a sensorless scheme has been mainly conducted.

In the sensorless control of the SRM, it is necessary to detect an initial angular position. To this end, a detection method through forced alignment of a rotor and application of a pulse voltage has been used.

In the forced alignment method of the rotor, a voltage is applied to one phase to align a stator and a rotor at a desired position, such that initial driving may be made; however, damage of a system may be caused when the rotor should not rotate reversely in an application of an industrial system.

In addition, in the voltage pulse application method, in the case of a symmetrical three-phase SRM, it is easy to detect the initial angle; however, in the case of a symmetrical two-phase SRM, current responses through pulse voltage application have the same value at different positions, such that it is difficult to detect the initial angle.

FIGS. 1A and 1B show pulse current response characteristics for detecting initial positions of symmetrical three-phase and two-phase SRMs.

Referring to the pulse current in the symmetrical three-phase SRM of FIG. 1A, all of pulse current responses of three-phases at each position are different according to initial positions of a rotor, such that the initial position of the rotor may be easily detected.

However, in the case of the symmetrical two-phase SRM shown in FIG. 1B, pulse current responses of two-phases has the same magnitude at two different rotor positions and the two rotor positions may not be distinguished from each other in the current pulse response having the same magnitude, such that it is very difficult to detect the initial position of the rotor.

That is, in the symmetrical three-phase SRM of FIG. 1A, a detection current ics has the same magnitude at detection positions θ₁ and θ₂; however, ias and ibs have different magnitudes at the same position, such that the detection positions θ₁ and θ₂ may be easily distinguished from each other.

However, in FIG. 1B, a detection current ias has the same magnitude at detection positions θ₁ and θ₂ and a detection current ibs has the same magnitude at the same position, such that it is very difficult to detect the initial position of the rotor.

However, in a general two-phase SRM application, tun-direction rotation has been applied to a fan, a blower, and a compressor. In this uni-direction rotation, a two-phase SRM having an asymmetrical inductance form capable of widely using a positive torque area and suppressing a torque ripple in view of design has been mainly used.

FIG. 2 shows pulse current response characteristics of a two-phase SRM having an asymmetrical inductance form. In the case of the response characteristics shown in FIG. 2, unlike the symmetrical two-phase SRM, an initial positional angle for a B phase current ibs response has the same characteristics at θ₁ and θ₂; however, ias responses at each position have a different corresponding to Δi, such that it is relatively easily to detect an initial position as compared to the symmetrical two-phase SRM. However, since the difference is significantly small and a difference in current responses at another phase in a specific positional period is also significantly small, such that it is difficult to precisely detect an initial position.

### PRIOR ART DOCUMENT

### Patent Document

(Patent Document 1) Korean Patent Laid-Open Publication No. 2005-2151

### SUMMARY OF THE INVENTION

The present invention has been made in an effort to provide an initial driving apparatus and method of a two-phase switched reluctance motor (SRM) capable of allowing stably initial driving to be made by detecting an initial position of a rotor using a difference in measured current of each phase detected by applying a voltage pulse.

Further, the present invention has been made in an effort to provide an initial driving apparatus and method of a two-phase SRM capable of allowing stably initial driving to be made by detecting a position of a rotor through measurement of a current output by applying a pulse voltage to a phase coil of a non-excited phase.

According to a preferred embodiment of the present invention, there is provided an initial driving apparatus of a two-phase switched reluctance motor (SRM), the initial driving apparatus including: a driving unit applying a pulse voltage to each of phase coils of the two-phase SRM; a current measuring unit measuring and outputting currents of each of the phase coils of the two-phase SRM; a memory storing data currents of each of the phase coils and differences between the data currents according to relative positions of rotor salient poles and stator salient poles of the two-phase SRM therein; and a controlling unit comparing the currents measured in the current measuring unit and a difference between the currents with the data currents and the difference between the data currents stored in the memory to determine an initial position, thereby initially driving the SRM.

The initial driving apparatus may further include a pulse generating unit generating the pulse voltage to provide the generated pulse voltage to the driving unit, wherein the driving unit applies the pulse voltage generated in the pulse generating unit to each of the phase coils.

The controlling unit may apply the pulse voltage to the phase coil that is not excited after initial driving, compares the current measured with respect to a corresponding phase coil in the current measuring unit with the data current of the corresponding phase coil stored in the memory to determine a position of a rotor, and then drives the two-phase SRM.

The controlling unit may calculate the difference between the currents of the phase coils measured in the current measuring unit, compare the difference between the measured currents with the difference between the data currents stored in the memory to determine estimated initial positions, and compare the measured currents with the respective data currents to determine an initial position.

The controlling unit may include: a difference calculator calculating the difference between the currents of the phase coils measured in the current measuring unit; an estimated initial position determinator comparing the difference between the data currents stored in the memory and the difference between the measured currents calculated in the difference calculator with each other to determine estimated initial positions; a phase difference calculator comparing the currents of the phase coils measured in the current measuring unit with the respective data currents to calculate a difference therebetween; and a position determinator determining the initial position from the estimated initial positions determined in the estimated initial position determinator based on the difference calculated in the phase difference determinator.

The estimated initial position determinator may compare the difference between the data currents stored in the memory and the difference between the measured currents calculated in the difference calculator with each other to determine that positions corresponding to the difference between the data currents closest to the difference between the measured currents are the estimated initial positions.

The position determinator may determine that an estimated initial position at which the difference calculated in the phase difference calculator is small is the initial position.

According to another preferred embodiment of the present invention, there is provided an initial driving method of a two-phase SRM, the initial driving method including: (A) applying, in a driving unit, a pulse voltage to each of phase coils of the two-phase SRM; (B) measuring and outputting, in a current measuring unit, currents of each of the phase coils of the two-phase SRM; and (C) comparing, in a controlling unit, the currents measured in the current measuring unit and a difference between the currents with data currents and a difference between the data currents stored in a memory to determine an initial position, thereby initially driving the SRM.

The initial driving method may further include: (D) applying, in the controlling unit, the pulse voltage to the phase coil that is not excited after initial driving to measure a current of a corresponding phase coil; and (E) comparing, in the controlling unit, the measured current with the data current of the corresponding phase coil stored in the memory to determine a position of a rotor, thereby driving the two-phase SRM.

Step (C) may include: (F) calculating, in the controlling unit, the difference between the currents of the phase coils measured in the current measuring unit and comparing the difference between the measured currents with the difference between the data currents stored in the memory to determine estimated initial positions; and (G) comparing, in the controlling unit, the measured currents with the respective corresponding data currents to determine positions of rotor salient poles and stator salient poles.

Step (F) may include: (H) calculating a difference between the currents of the phase coils measured in the current measuring unit; and (I) comparing the difference between the data currents stored in the memory and the difference between the measured currents calculated in a difference calculator to determine the estimated initial positions.

Step (G) may include: (J) comparing, in the controlling unit, the currents of the phase coils measured in the current measuring unit with the respective corresponding data currents to calculate a difference therebetween; and (K) determining, in the controlling unit, the initial position from the estimated initial positions determined in an estimated initial position determinator based on the difference calculated in step (J).

### BRIEF DESCRIPTION OF THE DRAWINGS

The above and other objects, features and advantages of the present invention will be more clearly understood from the following detailed description taken in conjunction with the accompanying drawings, in which:

FIGS. 1A and 1B are views showing pulse current response characteristics for detecting initial positions of symmetrical three-phase and two-phase SRMs;

FIG. 2 is a view showing pulse current response characteristics of a two-phase SRM having an asymmetrical inductance form;

FIG. 3 is a view showing a configuration of an initial driving apparatus of a two-phase SRM according to a preferred embodiment of the present invention;

FIG. 4 is a view showing a structure of the two-phase SRM of FIG. 3;

FIG. 5 is a view showing data currents stored in a memory of FIG. 3 and a different between the data currents;

FIG. 6 is a view describing a process of determining an initial position performed in a controlling unit of FIG. 3;

FIG. 7 is a detailed block diagram of the controlling unit of FIG. 3; and

FIG. 8 is a flow chart of an initial driving method of a two-phase SRM according to the preferred embodiment of the present invention.

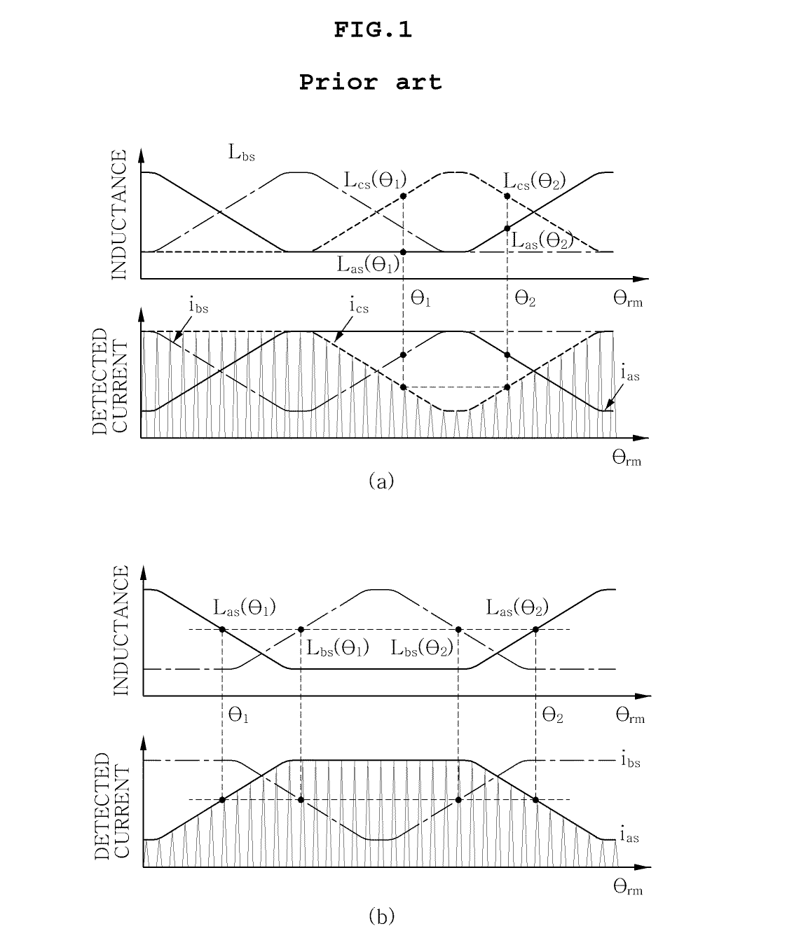

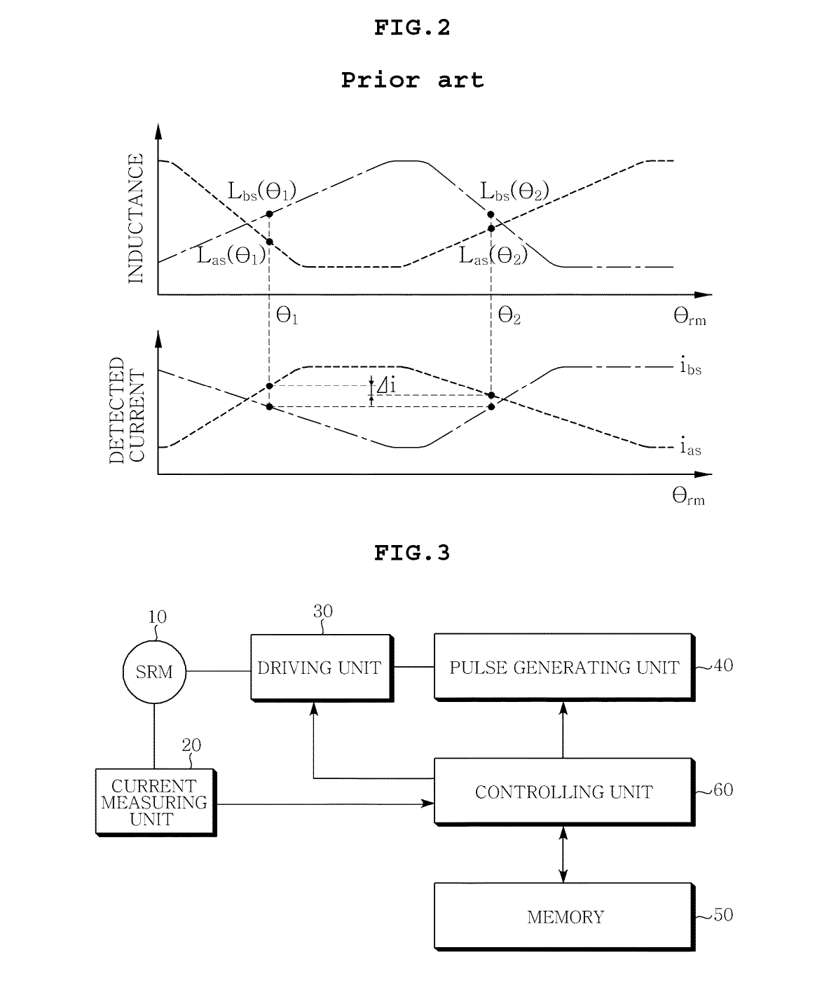

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant to descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

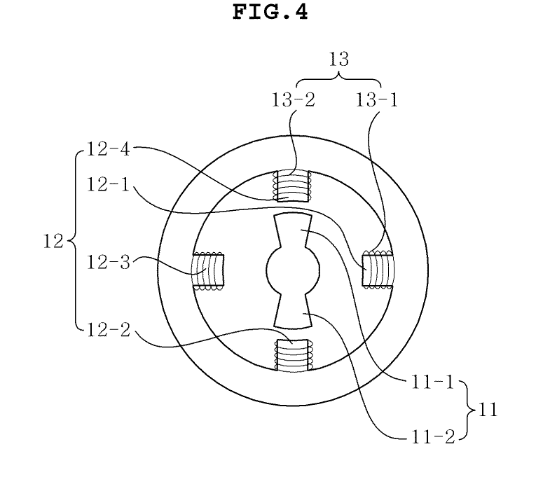

FIG. 3 is a view showing a configuration of an initial driving apparatus of a two-phase SRM according to a preferred embodiment of the present invention.

Referring to FIG. 3, the initial driving apparatus of a two-phase SRM according to the preferred embodiment of the present invention is configured to include a two-phase SRM 10, a current measuring unit 20, a driving unit 30, a pulse generating unit 40, a memory 50, and a controlling unit 60.

The two-phase SRM 10 includes a rotor 11, a stator 12, and a coil 13 as shown in FIG. 4.

In addition, the rotor 11 is formed with two rotor salient poles 11-1 and 11-2, and the stator 12 is formed with four stator salient poles 12-1 to 12-4 facing the rotor salient poles 11-1 and 11-2. Further, two-phase coils 13-1 and 13-2 are wound around the four stator salient poles 12-1 to 12-4.

The two-phase SRM 10 is configured only of an iron core without any excitation device, for example, a winding of a coil or a permanent magnet.

Therefore, when a current flows in the coil 13 from the outside, a reluctance torque moving the rotor 11 toward the coil 13 by magnetic force generated from the coil 13 is generated, such that the rotor 11 rotates in a direction in which resistance of a magnetic circuit is minimized. The two-phase SRM may have various structures such as a 8/4 structure, and the like, in which it includes eight stator salient poles and four rotor salient poles, in addition to a 4/2 structure in which it includes four stator salient poles and two rotor salient poles as shown in FIG. 4.

Next, the current measuring unit 20 is connected to each of the two-phase coils 13-1 and 13-2 wound around the four stator salient poles 12-1 to 12-4 to measure and output a winding current of the two-phase coils 13-1 and 13-2.

Meanwhile, the driving unit 30 drives the SRM 10 according to a control signal applied from the controlling unit 60, and receives a pulse voltage generated in the pulse generating unit 40 to apply the pulse voltage to each of the phase coils 13-1 and 13-2 of the SRM 10 at the time of detection of an initial position.

In addition, the driving unit 30 applies the pulse voltage generated in the pulse generating unit 40 to the phase coil 13-1 or 13-2 that is not excited at the time of initial driving.

Further, the pulse generating unit 40 generates the pulse voltage to output the generated pulse voltage to the driving unit 30.

The pulse voltage generated in the pulse generating unit 40 is applied to the phase coils 13-1 and 13-2 through the driving unit 30. At this time, the current detecting unit 20 measures and outputs the winding current of each of the phase coils 13-1 and 13-2.

In addition, the memory 50 stores currents (hereinafter, referred to as data currents) flowing when the pulse voltage is applied to each of the phase coils 13-1 and 13-2 and differences between the currents (hereinafter, referred to as data current differences) according to all relative positions of the rotor salient poles 11-1 and 11-2 and the stator salient poles 12-1 to 12-4 therein.

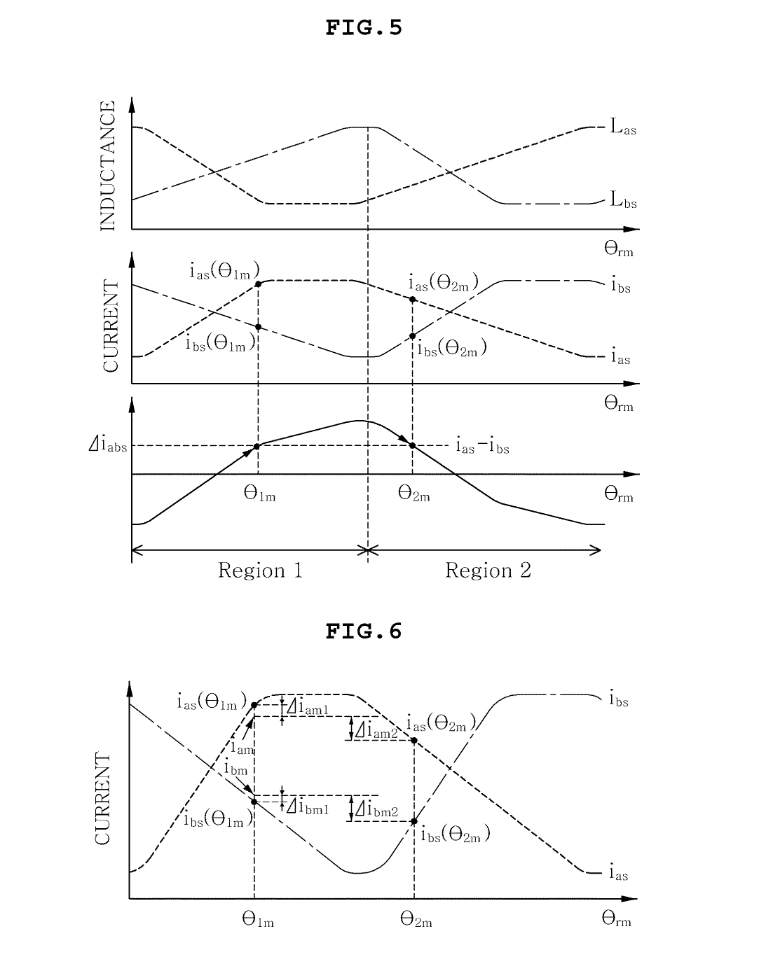

That is, the memory 50 stores a data current ias flowing in a phase coil (hereinafter, referred to as a U phase coil) denoted by a reference numeral 13-1 and a data current ibs flowing to a phase coil (hereinafter, referred to as a V phase coil) denoted by a reference numeral 13-2 and the current difference (that is, ias-ibs) between the data currents of the two-phase coils 13-1 and 13-2 according to all positions of the stator salient poles 11-1 and 11-2 and the rotor salient poles 12-1 to 12-4 therein, as shown in FIG. 5.

The controlling unit 60 outputs the control signal to the driving unit 30, calculates the difference between the measured currents of each of the phase coils measured in the current measuring unit 30, and compares the calculated difference with a data current difference stored in the memory 50 to detect a current position.

Further, the controlling unit 60 generates the control signal based on the detected initial position and outputs the control signal to the driving unit 30 to initially drive the SRM 10.

In addition, the controlling unit 60 detects a position of the rotor using the current measured by applying the pulse voltage to the phase coil 13-1 or 13-2 that is not excited at the time of the initial driving to drive the SRM 10.

An operation of the initial driving apparatus of a two-phase SRM according to the embodiment of the present invention will be described.

First, the controlling unit 60 applies to the pulse voltage generated in the pulse generating unit 40 to the driving unit 30 to allow the pulse voltage to be applied to each of the phase coils 13-1 and 13-2, in order to detect relative initial positions of the rotor salient poles 11-1 and 11-2 and the stator salient poles 12-1 to 12-4.

Then, the current measuring unit 20 measures and outputs phase currents of each of the phase coils 13-1 and 13-2.

When the current measuring unit 20 measures and outputs the phase currents of each of the phase coils 13-1 and 13-2 as described above, the controlling unit 60 calculates a difference between to two measured currents (a measured current difference), compares the difference with a data current difference stored in the memory 50 to detect the closest data current difference, and then selects a corresponding positional angle (hereinafter, referred to as an estimated initial position).

Here, each of estimated initial positions associated with a corresponding data current difference are present in a region 1 in which a data current difference monotonically increases and in a region 2 in which the data current difference monotonically decreases as shown in FIG. 5. That is, the number of estimated initial positions is two.

Therefore, the controlling unit 60 compares the measured currents of each of the phase coils 13-1 and 13-2 with the data current stored in the memory 50 and calculates differences between the respective measured currents at the respective estimated initial positions to determine that an estimated initial position at which the sum of the differences is the smallest is a determined initial position, in order to determine which of the two estimated initial positions corresponds to the data current difference.

Describing this with reference to FIG. 6, the controlling unit 60 calculates the sum of a U phase differences Δiₐₘ₁ between a U phase measured current iam and a U phase data current ias and a V phase difference Δ_{bm1} between a V phase measured current ibm and a V phase data current ibs at a first estimated initial position θ₁ₘ.

In addition, the controlling unit 60 calculates the sum of a U phase differences Δiₐₘ₂ between a U phase measured current iam and a U phase data current ias and a V phase difference Δi_{bm2} between a V phase measured current ibm and a V phase data current ibs at a second estimated initial position θ₂ₘ.

Then, the controlling unit 60 compares the sum of the differences at the first estimated initial position and the sum of the differences at the second estimated initial position with each other to determine that the estimated initial position at which the sum of the differences is relatively small is the determined initial position.

As described above, when the initial position is determined, the controlling unit 60 applies the control signal to the driving unit 30 using the initial position to drive the SRM 10.

Next, the controlling unit 60 controls the driving unit 30 to allow the pulse voltage generated in the pulse generating unit 40 to be applied to the phase coil 13-1 or 13-2 that is not excited at the time of the initial driving, compares the current measured in the current measuring unit 20 with the data current of the corresponding phase coil 13-1 or 13-2 stored in the memory 50 to detect the position of the rotor, and then generates and outputs the control signal based on the position of the rotor.

With the initial driving apparatus of a two-phase SRM according to the preferred embodiment of the present invention, the initial position of the rotor is detected using an error of the measured currents of each phase detected by applying a voltage pulse in a stop state, thereby making it possible to allow stable initial driving to be made.

With the initial driving apparatus of a two-phase SRM according to the preferred embodiment of the present invention, the position of the rotor is detected using the measured currents of each phase detected by applying a voltage pulse at the time of the initial driving, thereby making it possible to allow stable driving to be made.

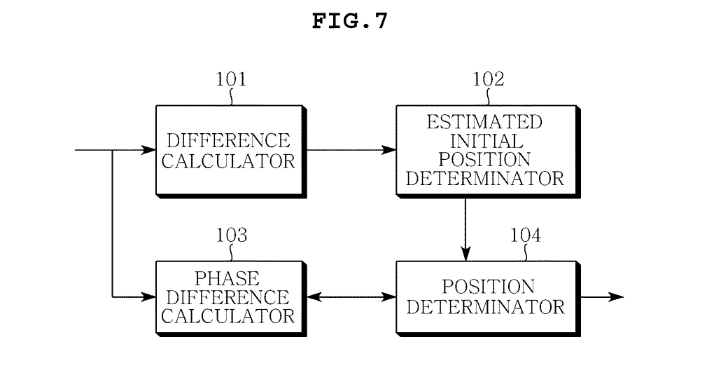

FIG. 7 is a detailed block diagram of the controlling unit of FIG. 3.

Referring to FIG. 7, the controlling unit of FIG. 3 is configured to include a difference calculator 101, an estimated initial position determinator 102, a phase difference calculator 103, and a position determinator 104.

Here, the difference calculator 101 calculates and outputs a measured current difference between two measured currents of phase coils measured in the current measuring unit.

In addition, the estimated initial position determinator 102 compares the measured current difference calculated in the difference calculator 101 with a data current difference stored in the memory and determines the data current difference closest to the measured current difference to determine estimated initial positions positioned in a monotonic increase period and a monotonic decrease period corresponding to the determined data current difference.

In this case, since each of the estimated initial positions corresponding to the data current difference closest to the measured current difference is present in the monotonic increase region and the monotonic decrease region, the estimated initial position determinator 101 may not recognize which of the estimated initial positions is appropriate.

Therefore, in order to determine two estimated initial positions, the phase difference calculator 103 compares the detection current and the data current with each other for each phase to calculate and output differences.

Then, the position determinator 104 compares the sums of the differences for each measured current calculated with respect to the two estimated initial positions with each other to determine that the estimated initial position at which the sum is the smallest is a determined initial position.

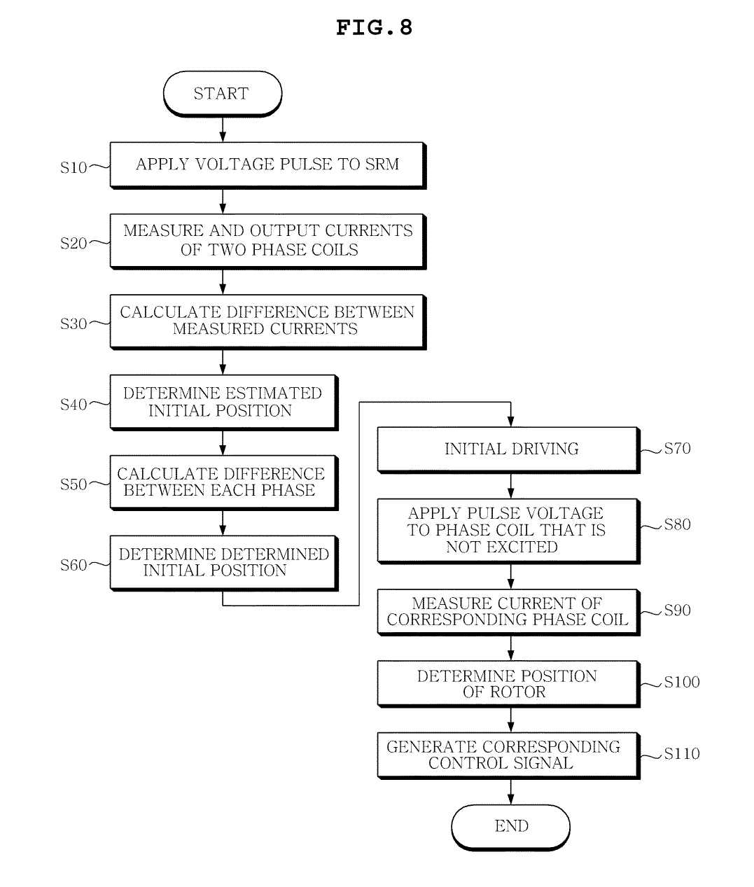

FIG. 8 is a flow chart of an initial driving method of a two-phase SRM according to the preferred embodiment of the present invention.

Referring to FIG. 8, in the initial driving method of a two-phase SRM according to the embodiment of the present invention, a controlling unit first applies a pulse voltage generated in the pulse generating unit to the driving unit to allow the pulse voltage to be applied to each of phase coils of the SRM (S10).

Then, the current measuring unit measures currents of the phase coils according to the application of the voltage pulse to output the measured current (S20).

When the current measuring unit measures and outputs the currents of the phase coils according to the application of the voltage pulse, the controlling unit calculates a difference between the measured currents of two-phase coils (S30) and compares the calculated difference between the measured currents with a data current difference stored in the memory to determine that a position corresponding to a data current difference having the smallest value is an estimated initial position (S40).

At the time, the controlling unit needs to select any one of two corresponding estimated initial positions.

To this end, the controlling unit compares the currents measured in each of the phase coils with a data current stored in the memory to calculate differences for each phase (S50), calculates the sum of the differences to determine that an estimated initial position having a smaller magnitude is a determined initial position (S60), and then performs initial driving using the determined initial position (S70).

Then, the controlling unit controls the driving unit to allow the pulse voltage generated in the pulse generating unit to be applied to the phase coil that is not excided at the time of initial driving (S80), compares the current measured (S90) in the current measuring unit with the data current of the corresponding phase coil stored in the memory to detect the position of the rotor (S100), and then generates and outputs the control signal based on the position of the rotor (S110).

With the initial driving method of a two-phase SRM according to the preferred embodiment of the present invention, the initial position of the rotor is detected using an error of the measured currents of each phase detected by applying a voltage pulse in a stop state, thereby making it possible to allow stable initial driving to be made.

With the initial driving method of a two-phase SRM according to the preferred embodiment of the present invention, the position of the rotor is detected using the measured currents of each phase detected by applying a voltage pulse at the time of the initial driving, thereby making it possible to allow stable driving to be made.

As described above, according to the preferred embodiment of the present invention, the initial position of the rotor is detected using a difference of the measured currents of each phase detected by applying a voltage pulse in a stop state, thereby making it possible to allow stable initial driving to be made.

In addition, according to the preferred embodiment of the present invention, the accurate position of the rotor is detected using the measured currents detected by applying a voltage pulse to the phase coil of the non-excited phase at the time of the initial driving, thereby making it possible to allow stable driving to be made.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. An initial driving apparatus of a two-phase switched reluctance motor (SRM), the initial driving apparatus comprising:
a driving unit applying a pulse voltage to each of phase coils of the two-phase SRM;
a current measuring unit measuring and outputting currents of each of the phase coils of the two-phase SRM;
a memory storing data currents of each of the phase coils and differences between the data currents according to relative positions of rotor salient poles and stator salient poles of the two-phase SRM therein; and
a controlling unit comparing the currents measured in the current measuring unit and a difference between the currents with the data currents and the difference between the data currents stored in the memory to determine an initial position, thereby initially driving the SRM.

2. The initial driving apparatus as set forth in claim 1, further comprising a pulse generating unit generating the pulse voltage to provide the generated pulse voltage to the driving unit,
wherein the driving unit applies the pulse voltage generated in the pulse generating unit to each of the phase coils.

3. The initial driving apparatus as set forth in claim 2, wherein the controlling unit applies the pulse voltage to the phase coil that is not excited after initial driving, compares the current measured with respect to a corresponding phase coil in the current measuring unit with the data current of the corresponding phase coil stored in the memory to determine a position of a rotor, and then drives the two-phase SRM.

4. The initial driving apparatus as set forth in claim 1, wherein the controlling unit calculates the difference between the currents of the phase coils measured in the current measuring unit, compares the difference between the measured currents with the difference between the data currents stored in the memory to determine estimated initial positions, and compares the measured currents with the respective corresponding data currents to determine an initial position.

5. The initial driving apparatus as set forth in claim 1, wherein the controlling unit includes:
a difference calculator calculating the difference between the currents of the phase coils measured in the current measuring unit;
an estimated initial position determinator comparing the difference between the data currents stored in the memory and the difference between the measured currents calculated in the difference calculator with each other to determine estimated initial positions;
a phase difference calculator comparing the currents of the phase coils measured in the current measuring unit with the respective data currents to calculate a difference therebetween; and
a position determinator determining the initial position from the estimated initial positions determined in the estimated initial position determinator based on the difference calculated in the phase difference determinator.

6. The initial driving apparatus as set forth in claim 5, wherein the estimated initial position determinator compares the difference between the data currents stored in the memory and the difference between the measured currents calculated in the difference calculator with each other to determine that positions corresponding to the difference between the data currents closest to the difference between the measured currents are the estimated initial positions.

7. The initial driving apparatus as set forth in claim 5, wherein the position determinator determines that an estimated initial position at which the difference calculated in the phase difference calculator is small is the initial position.

8. An initial driving method of a two-phase SRM, the initial driving method comprising:
(A) applying, in a driving unit, a pulse voltage to each of phase coils of the two-phase SRM;
(B) measuring and outputting, in a current measuring unit, currents of each of the phase coils of the two-phase SRM; and
(C) comparing, in a controlling unit, the currents measured in the current measuring unit and a difference between the currents with data currents and a difference between the data currents stored in a memory to determine an initial position, thereby initially driving the SRM.

9. The initial driving method as set forth in claim 8, further comprising:
(D) applying, in the controlling unit, the pulse voltage to the phase coil that is not excited after initial driving to measure a current of a corresponding phase coil; and
(E) comparing, in the controlling unit, the measured current with the data current of the corresponding phase coil stored in the memory to determine a position of a rotor, thereby driving the two-phase SRM.

10. The initial driving method as set forth in claim 8, wherein step (C) includes:
(F) calculating, in the controlling unit, the difference between the currents of the phase coils measured in the current measuring unit and comparing the difference between the measured currents with the difference between the data currents stored in the memory to determine estimated initial positions; and
(G) comparing, in the controlling unit, the measured currents with the respective corresponding data currents to determine positions of rotor salient poles and stator salient poles.

11. The initial driving method as set forth in claim 10, wherein step (F) includes:
(H) calculating a difference between the currents of the phase coils measured in the current measuring unit; and
(I) comparing the difference between the data currents stored in the memory and the difference between the measured currents calculated in a difference calculator to determine the estimated initial positions.

12. The initial driving method as set forth in claim 10, wherein step (G) includes:
(J) comparing, in the controlling unit, the currents of the phase coils measured in the current measuring unit with the respective corresponding data currents to calculate a difference therebetween; and
(K) determining, in the controlling unit, the initial position from the estimated initial positions determined in an estimated initial position determinator based on the difference calculated in step (J).
